(19) United States
(12) Patent Application Publication
(10) Pub. No.: US 2012/0049125 A1
(43) Pub. Date: Mar. 1, 2012

(54) ELECTROPHORETIC DISPERSION

(76) Inventors: Hui Du, Milpitas, CA (US); Yu Li, Fremont, CA (US); Wie-Ho Ting, Taichung City (TW); Yayong Liu, Fremont, CA (US); Haiyan Gu, Fremont, CA (US); HongMei Zang, Fremont, CA (US)

(21) Appl. No.: 13/215,562

(22) Filed: Aug. 23, 2011

Related U.S. Application Data
(60) Provisional application No. 61/376,636, filed on Aug. 24, 2010.

(51) Int. Cl. H01B 1/12; C08F 8/36; C08F 267/06; C08F 8/42; C08F 2/06; C08F 20/24

(52) U.S. Cl. 252/500; 526/117; 526/213; 525/269; 525/267; 525/340; 525/353

(57) ABSTRACT

The present invention is directed to methods for the preparation of pigment particles suitable for use in an electrophoretic dispersion, particularly an electrophoretic dispersion in a fluorinated solvent. The method comprises: a) treating pigment particles to incorporate reactive groups onto the surface of the pigment particles; and b) reacting said reactive group with a functional group in a fluorinated monomer, oligomer or polymer to form a polymer layer over the surface of the pigment particles.

This application claims the benefit of U.S. Provisional Application No. 61/376,636, filed Aug. 24, 2010; which is incorporated herein by reference in its entirety.

### FIELD OF THE INVENTION

The present invention is directed to the preparation of pigment particles that can be used to form an electrophoretic dispersion, in particular an electrophoretic dispersion in a fluorinated solvent.

### BACKGROUND OF THE INVENTION

An electrophoretic display (EPD) is a non-emissive device based on the electrophoresis phenomenon influencing charged pigment particles dispersed in a dielectric solvent. An EPD typically comprises a pair of spaced-apart plate-like electrodes. At least one of the electrode plates, typically on the viewing side, is transparent. An electrophoretic dispersion composed of a dielectric solvent with charged pigment particles dispersed therein is enclosed between the two electrode plates.

An electrophoretic dispersion may have one type of charged pigment particles dispersed in a solvent or solvent mixture of a contrasting color. In this case, when a voltage difference is imposed between the two electrode plates, the pigment particles migrate by attraction to the plate of polarity opposite that of the pigment particles. Thus, the color showing at the transparent plate may be either the color of the solvent or the color of the pigment particles. Reversal of plate polarity will cause the particles to migrate back to the opposite plate, thereby reversing the color.

Alternatively, an electrophoretic dispersion may have two types of pigment particles of contrasting colors and carrying opposite charges, and the two types of pigment particles are dispersed in a clear solvent or solvent mixture. In this case, when a voltage difference is imposed between the two electrode plates, the two types of pigment particles would move to the opposite ends (top or bottom) in a display cell. Thus one of the colors of the two types of the pigment particles would be seen at the viewing side of the display cell.

For all types of electrophoretic displays, the dispersion contained within the individual display cells of the display is undoubtedly one of the most crucial parts of the device. The composition of the dispersion determines, to a large extent, the lifetime, contrast ratio, switching rate and bistability of the device.

In an ideal dispersion, the charged pigment particles remain separate and do not agglomerate or stick to each other or to the electrodes, under all operating conditions. In addition, all components in the dispersion must be chemically stable and compatible with the other materials present in an electrophoretic display.

### BRIEF DISCUSSION OF THE DRAWINGS

FIG. 1 is a charge distribution chart in which the positively charged white pigment particles are collected on the “−” electrode as shown by the higher reflectance, which leaves the black pigment particles as the background color measured through the ITO glass on the “+” electrode.

### SUMMARY OF THE INVENTION

The first aspect of the present invention is directed to a method for the preparation of pigment particles useful for an electrophoretic display, which method comprises
a) treating pigment particles to incorporate reactive groups onto the surface of the pigment particles; and
b) reacting said reactive group with a functional group in a fluorinated monomer, oligomer or polymer to form a polymer layer over the surface of the pigment particles.

The second aspect of the present invention is directed to a method for the preparation of pigment particles useful for an electrophoretic display, which method comprises reacting the pigment particles with a compound comprising both a fluorinated backbone and groups attachable to the surface of the pigment particles.

The present invention is also directed to an electrophoretic dispersion comprising pigment particles prepared according to any of the methods described herein, dispersed in a fluorinate solvent. The dispersion may comprise only one type of pigment particles prepared according to any of the methods described herein. The dispersion may comprise two types of pigment particles at least one type of which is prepared according to any of the methods described herein.

### DETAILED DESCRIPTION OF THE INVENTION

The present invention is directed to methods for the preparation of pigment particles suitable for use in an electrophoretic dispersion, in particular an electrophoretic dispersion in a fluorinated solvent.

The first aspect of the present invention is directed to a method comprising
a) treating pigment particles to incorporate reactive groups onto the surface of the pigment particles; and
b) reacting said reactive group with a functional group in a fluorinated monomer, oligomer or polymer to form a polymer layer over the surface of the pigment particles.

In other words, the surface of the pigment particles are pre-treated to introduce reactive groups onto the surface, which is capable of grafting and/or polymerizing with a fluorinated monomer or macromolecule, in order to coat a polymer layer over the surface of the pigment particles.

In the first embodiment of this aspect of the invention, the surface treatment may be carried out with a silane material (e.g., γ-methacryloxy-propyltrimethoxysilane) to introduce vinyl reactive groups to the surface of the pigment particles. Other agents which may be used to introduce the vinyl reactive groups include acrylic acid, vinyl phosphoric acid and the like. In general, the surface treatment material may be selected based on the type of the pigment particles and the fluorinated monomer, oligomer or polymer to be polymerized over the particle surface. The surface treatment conditions would also depend on the materials used. For example, metal oxide particles can be reacted with a silane coupling agent or a vinyl acid. For the silane treatment, a base such as ammonium hydroxide is preferred as a catalyst to increase the silane coupling efficiency. However, in the case of a vinyl acid, a catalyst is not necessary; but a high reaction temperature and a longer reaction time are preferred to achieve high coupling efficiency.

The fluorinated monomer, oligomer or polymer used for grafting a polymer layer on the surface of the pigment particles may be represented by the following formulas:

R_{f}-A (Formula Ia)

A-R_{f}-A′ (Formula Ib)

wherein R_{f} is a fluorinated moiety, which may be a fluorinated low-molecular-weight (molecular weight of 50-1,000 Daltons) group or a fluorinated polymeric or oligomeric chain, and A and A′ are independently a functional group capable of polymerizing with the reactive group already planted on the surface of the pigment particles.

In Formula Ib, A and A′ may be the same or different. They may be independently acrylate or methacrylate.

The low-molecular-weight group may be C₃₋₄₀alkyl, C₆₋₁₈aryl, C₆₋₁₈arylC₃₋₄₀alkyl or C₃₋₄₀alkylC₆₋₁₈aryl.

When R_{f} is a fluorinated polymeric or oligomeric chain, it may be prepared by radical polymerization, condensation polymerization, ring-opening polymerization or the like. Suitable monomers for the preparation of R_{f} include, but are not limited to, fluorine-substituted acrylate, fluorine-substituted methacrylate, fluorine-substituted styrene, fluorine-substituted vinyl, fluorine-substituted oxirane, fluorine-substituted cyclic ether, perfluoropropylene oxide and perfluorofurane. R_{f} may comprise at least 20 wt %, preferably at least 50 wt %, of fluorine. The average molecular weight (MW) of R_{f} may be in the range from about 300 to about 100,000, preferably from about 500 to about 30,000. In one example, R_{f} may be a fluoropolyether. In another example, R_{f} may be a perfluoropolyether.

The structure of the fluorinated monomer or macromolecule used for polymerization is important because it may affect the compatibility of the pigment particles to the solvent, which, in turn, will impact on the stability, agglomeration status and packing density of the pigment particles, upon driving. It may also impact on the bistability of the display device. A polymer structure formed from properly selected fluorinated monomer or macromolecule will minimize agglomeration of the pigment particles among themselves, agglomeration between different types of pigment particles, or agglomeration of the particles with a charge controlling agent in the dispersion.

In the case of pigment particles already treated to introduce vinyl groups on the surface, fluorinated acrylate monomers or fluorinated methacrylate monomers may be used for polymerization on the particle surface. The polymerization process is typically performed under the same or similar conditions as conventional free-radical polymerization. Polymerization employing the above fluorinated acrylate or methacrylate monomers may be carried out at a temperature in the range from about 50 to about 100° C., preferably in the range from about 60 to about 80° C., in the presence of a free radical initiator such as 2,2′-azobis(isobutyronitrile).

The graft content of polymer on the particle surface may affect the dispersability of the particles in a fluorinated solvent. It has been found that to prevent agglomeration of the particles, a graft content is preferably about 3 to about 30 wt %, more preferably about 5 to about 20 wt % and most preferably about 10 to about 20 wt %.

In the presence of a charge controlling agent, the pigment particles tend to aggregate more severely in a fluorinated solvent. Therefore, monomers with longer fluorocarbon chains is necessary to prevent the particle agglomeration. Monomers with total carbon atoms of about 5 to about 30 are preferred. Monomers with total carbon atoms of about 10 to 20 are more desirable.

A cross-linking agent may also be added to facilitate crosslinking of the polymer layer on the particle surface. Commonly used crosslinking agents may be used, which include divinylbenzene or the like. The selection of the crosslinking agent obviously would depend on the fluorinated monomer or macromolecule used.

In the second embodiment, the surface of the pigment particles is pre-treated with a silane coupling agent having an isocyanante group, such as 3-isocyanatopropyltrimethoxysilane or 3-isocyanatopropyldimethyl-chlorosilane, to incorporate isocyanate reactive groups onto the particle surface.

The surface treatment step is then followed by a chemical reaction with a long chain stabilizer to be chemically bonded to the surface of the pigment particles. The long chain stabilizer is a fluorinated macromolecule, preferably terminated with a hydroxyl group or amine functional group, which will react with the isocyanate reactive groups already planted on the pigment surface.

The fluorinated long chain stabilizer generally has a molecular weight ranging from about 300 to about 4000, preferably from about 1500 to about 3000, or a mixture of fluorinated macromolecules of different molecular weights.

The fluorinated macromolecule comprises a fluorinated moiety which may be the same as the R_{f} described above. For example, the fluorinated macromolecule may be a hydroxyl or amine terminated fluoropolyether. The fluoropolyether may have the following chemical formula

F—(CF(CF₃)—CF₂—O)ₙ—CF₂CF₃

wherein n may range from about 10 to about 60.

In the third embodiment, the surface treatment and polymerization steps may be the same as those described above, except an additional coupling agent is included to introduce a charged or chargeable group. Examples of materials (or coupling agents) comprising a charged or chargeable group may include, but are not limited to, acrylic acid, 3-(trihydroxysilyl)propyl methylphosphonate and molecules with a sulfonic acid or sulfonate moiety. Other materials comprising charged groups such as pyrrolidinone, amide or amine may also be used.

The fourth embodiment is particularly suitable for the carbon black pigment particles. Carbon black particles have much lower density which allows them to form a more stable dispersion in a fluorinated solvent. The surface chemistry of the carbon black particles is also different from that of other types of particles. In this case, the surface treatment step (a) is preceded with an oxidation reaction to introduce acidic groups such as phenolic hydroxyl groups or carboxylic acid groups onto the surface of the carbon black particles. The oxidation may be carried out with nitric acid, sulfuric acid, a chlorate, a persulfate, a perborate, a percarbonate or the like. After oxidation, the surface treatment step (a) takes place to introduce the reactive groups such as the vinyl groups. The introduction of the vinyl groups is accomplished by reacting a vinyl compound bearing appropriate functional groups to be reacted with the acidic groups on the carbon black surface. This is then followed by the polymerization with a fluorinated monomer or oligomer as described as step (b) above, to generate a polymer layer on the carbon black particle surface.

The second aspect of the present invention is similar to the first aspect of the invention, except in the process, steps (a) and (b) are carried out in one step.

In other words, the second aspect of the invention is directed to a method comprising causing the pigment particles to react directly with a compound comprising both a fluorinated backbone and groups attachable to the surface of the pigment particles.

For example, the pigment particles may be directly reacted with a silane compound comprising both a fluorinated backbone and groups convertible to hydroxyl group (such as alkoxy, preferably trimethoxy or triethoxy).

The group convertible to a hydroxyl group can be hydrolyzed and then bonded to the pigment surface through a condensation reaction.

The fluorinated backbone is beneficial in stabilizing the pigment particles in a fluorinated solvent. The chain length of fluorinated backbone can be adjusted and controlled to achieve best pigment dispersability. Suitable fluorinated backbone may be the R_{f} as described above. In one example, the fluorinated backbone may be a perfluoropolyether.

An example of the silane compound suitable for this embodiment of the invention is Fomblin MD407, which is a perfluoropolyether (PFPE) with urethane dimethacrylate and urethane alkyl triethoxy silane end groups.

After surface modification according to the present invention, the pigment particles will have good dispersibility in a fluorinated solvent. Particle size can be between about 0.1 um to about 1.5 um, preferably between about 0.3 um to about 1.0 um.

The pigment particles prepared according to the present invention is particularly suitable for use in an electrophoretic dispersion in a fluorinated solvent.

The use of a fluorinated solvent in an electrophoretic dispersion has several advantages. For example, the fluorinated solvents usually have a much lower refractive index, resulting in more refractive index mismatch between the white particles and the solvent. This leads to a higher white reflectance. The fluorinated solvents also have a higher density, which is favorable for stabilizing inorganic pigments in the dispersion. In addition, fluorinated solvents are often preferable because they are chemically stable.

In the context of the present invention, suitable fluorinated solvents generally have low vapor pressure, low viscosity and a dielectric constant in the range of about 1.7 to about 30, more preferably in the range of about 1.7 to about 5.

Examples of suitable fluorinated solvents may include, but are not limited to, perfluorinated solvents such as perfluoroalkanes or perfluorocycloalkanes (e.g., perfluorodecalin), perfluoroarylalkanes (e.g., perfluorotoluene or perfluoroxylene), perfluoro-tert-amines, perfluoropolyethers such as those from Solvay Solexis and perfluoropolyethers HT series and hydrofluoropolyethers (ZT series) from Solvay Solexis, FC-43 (heptacosafluorotributylamine), FC-70 (perfluorotri-n-pentylamine), PF-5060 or PF-5060DL (pefluorohexane) from 3M Company (St. Paul, Minn.), low molecular weight (preferably less than 50,000, more preferably less than 20,000) polymers or oligomers such as poly(perfluoropropylene oxide) from TCI America (Portland, Oreg.), poly(chlorotrifluoroethylene) such as Halocarbon Oils from Halocarbon Product Corp. (River Edge, N.J.) and Demnum lubricating oils from Daikin Industries. Perfluoropolyethers and hydrofluoropolyethers such as HT-170, HT-200, HT-230, ZT-180 (Solvay Solexis) and trifluoro(trifluoromethyl)-oxirane homopolymers such as K6 and K-7 fluids (Dupont) are particularly useful.

The present invention may be widely applied to any types of pigment particles. For example, it may be applied to black particles including inorganic, organic or polymeric black particles. Examples may include manganese ferrite black spinel, copper chromite black spinel, carbon black, zinc sulfide, stained black polymer particles or particles formed from other color absorbing materials.

The present invention may also be applicable to white particles, including also inorganic, organic or polymeric white particles. To achieve a high light scattering, pigments of a high refractive index are particularly useful. Suitable white pigment particles may include TiO₂, BaSO₄ and ZnO, with TiO₂ being the most preferred.

While black and white particles are specifically mentioned, it is understood that pigment particles of other colors may also be prepared according to the present invention.

The present invention is applicable to a one-particle or two-particle electrophoretic dispersion system in a fluorinated solvent.

In other words, the present invention may be directed to an electrophoretic dispersion comprising only one type of pigment particles prepared according to the present invention which are dispersed in a fluorinated solvent. The particles and the fluorinated solvent have contrasting colors.

Alternatively, the present invention may be directed to an electrophoretic dispersion comprising two types of pigment particles dispersed in a fluorinated solvent and at least one of the two types of the pigment particles is prepared according to the present invention. The two types of pigment particles carry opposite charge polarities and have contrasting colors. For example, the two types of pigment particles may be black and white respectively. In this case, the black particles may be prepared according to the present invention, or the white particles may be prepared according to the present invention, or both black and white particles may be prepared according to the present invention.

The pigment particles prepared according to the present invention, when dispersed in a fluorinated solvent, have many advantages. For example, the particles are easily dispersible in the fluorinated solvent. The particles prepared according to the present invention are especially advantageous in a two particle system, because they are easily compatible with other types of particles which are not prepared according to the present invention, thus leading to improved performance of a display device.

In the two particle system, if only one type of the pigment particles is prepared according to the present invention, the other type of pigment particles may be prepared by any other methods.

For example, the particles may be simply pigment particles or polymer encapsulated pigment particles. The former is pigment particles which are not microencapsulated or coated.

In order to match the density of the pigment particles to that of the fluorinated solvent in which the particles are dispersed, the pigment particles may be microencapsulated or coated with a polymer matrix to form the polymer encapsulated pigment particles. Any known microencapsulation techniques may be used to prepare such coated particles.

Examples of the microencapsulation technique may be those described in U.S. Pat. Nos. 7,110,162, 7,052,766 and 7,286,279, the contents of all of which are incorporated herein in their entirety by reference

The pigment particles prepared by the previously known techniques may also exhibit a natural charge, or may be charged explicitly using a charge control agent, or may acquire a charge when suspended in the fluorinated solvent. Suitable charge control agents are well known in the art; they may be polymeric or non-polymeric in nature, and may also be ionic or non-ionic, including ionic surfactants such as dye materials, sodium dodecylbenzenesulfonate, metal soap, polybutene succinimide, maleic anhydride copolymers, vinylpyridine copolymers, vinylpyrrolidone copolymer, (meth)acrylic acid copolymers or N,N-dimethylaminoethyl (meth)acrylate copolymers. Fluorosurfactants are particularly useful as charge controlling agents in a fluorinated solvent.

### EXAMPLES

### Example 1

### Preparation of Metal Oxide Black Pigment Particles

A. Surface Treatment

To a 1 L reactor, Black 444 (manganese ferrite black spinel, Shepherd, 40 g), isopropanol (IPA, 320 g), and γ-methacryloxypropyl-trimethoxysilane (Z-6030 by Dow Corning, 16 g) were added. The reactor was heated to 65° C. with mechanical stirring in a sonication bath. After 5 hours, the mixture was centrifuged at 6000 rpm for 10 minutes. The solids were redispersed in IPA, centrifuged, and dried at 50° C. under vacuum overnight to produce 38 g of the desired product.

B. Formation of a Polymeric Layer

To a 250 mL flask, the surface treated particles (2 g) prepared in Step A and 1,3-bis(trifluoromethyl benzene) (25 g) were added and sonicated for 30 minutes, followed by the addition of 1H,1H,2H,2H-perfluorodecyl acrylate (10 g) and azobisisobutyronitrile (AIBN, 25 mg). The flask was purged with Argon for 20 minutes and then heated to 80° C. After 19 hours, the polymer coated-particles were recovered by centrifugation at 6000 rpm for 10 minutes. The solids produced were re-dispersed in PFS2 (Solvay Solexis, 50 g) and centrifuged. This cycle was repeated twice and the solids were dried at 50° C. under vacuum to produce 1.8 g of the final product.

### Example 2

### Preparation of Negatively Charged Metal Oxide Black Pigment Particles

A. Surface Treatment

To a 250 mL flask, Black 444 (Shepherd, 10 g) and isopropanol (IPA, 100 mL) were added and sonicated for 30 minutes, followed by the addition of γ-methacryloxypropyl-trimethoxysilane (Z-6030 by Dow Corning, 10 g). The reactor was heated to 80° C. with magnetic stirring. After 24 hours, the mixture was centrifuged at 6000 rpm for 10 minutes. The solids were re-dispersed in IPA (100 mL), centrifuged and dried at 50° C. under vacuum overnight to produce the desired product.

B. Adding Negative Charge

To a 250 mL flask, the particles (5 g) prepared from Step A above, isopropyl alcohol (IPA, 50 mL), and acrylic acid (1 g) were added and sonicated for 5 minutes. The flask was heated to 80° C. with magnetic stirring. After 6 hours, the mixture was centrifuged at 6000 rpm for 10 minutes. The solids were re-dispersed in IPA (50 mL), centrifuged and dried at 50° C. under vacuum overnight to produce the desired product.

C. Formation of a Polymer Layer

To a 250 mL flask, the particles (2 g) prepared from Step B above and 25 g of 1,3-bis(trifluoromethyl benzene) were added and sonicated for 30 minutes, followed by the addition of 1H,1H,2H,2H-perfluorodecyl acrylate (10 g) and azobisisobutyronitrile (AIBN, 25 mg). The flask was purged with Argon for 20 minutes and then heated to 80° C. After 19 hours, the polymer coated-particles were recovered by centrifugation at 6000 rpm for 10 minutes. The solids produced were re-dispersed in PFS2 (Solvay Solexis, 50 g) and centrifuged. This cycle was repeated twice and the solids were dried at 50° C. under vacuum to produce 1.8 g of the final product.

### Example 3

### Preparation of Carbon Black Particles

A suspension of carbon black (Regal 350R, 10 g) and 65% nitric acid (100 g) was sonicated for 30 minutes and stirred for 24 hours at 100° C. After cooling to room temperature, the particles were collected by centrifugation and washed with deionized water. The resulted product was dried in vacuum at 60° C., yielding 8 g of the carbon black particles with carboxylic acid moiety on the surface (CB—COOH).

Eight (8) g of the CB—COOH was dispersed in 100 mL of dry tetrahydrofuran (THF) via 30 minute sonication. To this dispersion, 1,3-dicyclohexylcarbodiimide (4 g), N,N-(dimethylamino)pyridine (0.6 g) and hydroxyethyl acrylate (5 g) were added. The reaction was stirred by a magnetic stir bar overnight. The functionalized carbon black was then purified by multiple centrifugations in THF and methanol.

To a 250 mL flask, the functionalized carbon black (2 g) and 25 g of 1,3-bis(trifluoromethyl benzene) were added and sonicated for 30 minutes, followed by the addition of 1H,1H,2H,2H-perfluorodecyl acrylate (10 g) and azobisisobutyronitrile (AIBN, 25 mg). The flask was purged with Argon for 20 minutes and then heated to 80° C. After 19 hours, the polymer coated-carbon black particles were recovered by centrifugation at 6000 rpm after 10 minutes. The solids produced were re-dispersed in PFS2 (Solvay Solexis, 50 g) and centrifuged. This cycle was repeated twice and the solids were dried at 50° C. under vacuum to produce 1.8 g of the final product.

### Example 4

### Charge Distribution Study in Fluorinated Solvent

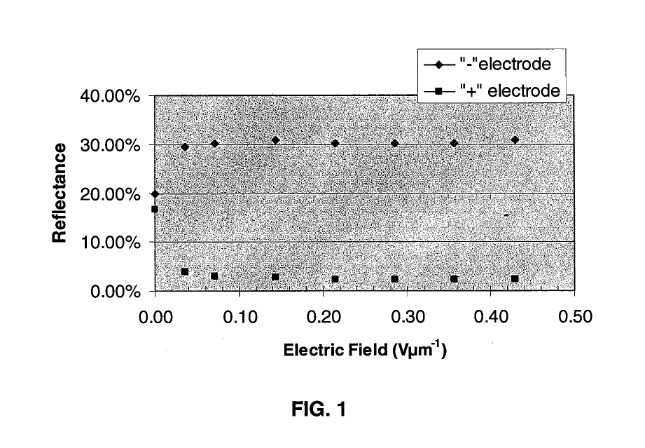

A dispersion was prepared by dispersing the black pigment particles prepared in Example 1 and the white pigment particles prepared according to U.S. Pat. No. 7,052,766 in a perfluorinated solvent (HT200) with a charge control agent. The dispersion was then injected into an ITO cell made of two ITO glasses with ˜125 μm gap. The two ITO glasses were connected to a DC voltage source with one as the negative (“−”) electrode and the other one as the positive (“+”) electrode. An electric field was formed perpendicular to the ITO glasses inside the cell. Any charged species would move toward an electrode having a charge polarity opposite of the charge polarity carried by the charged species, under the electric field (electrophoresis). In this experiment, the white pigment particles with the positive charge would move to be collected on the “−” electrode while the black pigment particles would move to be collected on the “+” electrode. With the increase of voltage or electric field strength, the white pigment particles would be more densely packed on the “−” electrode as shown by increasing whiteness. Reflectance was measured on both sides of the ITO glasses by using a spectrophotometer and plotted with electric field strength as shown in FIG. 1. This experiment demonstrates that the white and black pigment particles can be separated by the electric field and form an operable display device.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, materials, compositions, processes, process step or steps, to the objective, spirit and scope of the present invention. All such modifications are intended to be within the scope of the claims appended hereto.

What is claimed is:

1. A method for preparing pigment particles useful for an electrophoretic display, comprising:
a) treating pigment particles to incorporate reactive groups onto the surface of the pigment particles; and
b) reacting said reactive group with a functional group in a fluorinated monomer, oligomer or polymer to form a polymer layer over the surface of the pigment particles.

2. The method of claim 1, wherein step (a) the pigment particles are treated with a silane material.

3. The method of claim 2, wherein said silane material introduces vinyl reactive groups to the surface of the pigment particles.

4. The method of claim 1, wherein step (a) the pigment particles are treated with acrylic acid or vinyl phosphoric acid.

5. The method of claim 1, wherein the fluorinated monomer, oligomer or polymer has the following formulas
R_{f}-A (Formula Ia)
A-R_{f}-A′ (Formula Ib)
wherein R_{f} is a fluorinated low-molecular-weight group or a fluorinated polymeric or oligomeric chain, and
A and A′ are independently a functional group capable of polymerizing with the reactive group on the surface of the pigment particles.

6. The method of claim 5, wherein in Formula Ib, A and A′ are the same or different.

7. The method of claim 6, wherein A and A′ are independently acrylate or methacrylate.

8. The method of claim 5, wherein the fluorinated low-molecular weight group is a fluorinated C₃₋₄₀alkyl, a fluorinated C₆₋₁₈aryl, a fluorinated C₆₋₁₈arylC₃₋₄₀alkyl or a fluorinated C₃₋₄₀alkylC₆₋₁₈aryl.

9. The method of claim 5, wherein R_{f} comprises at least about 20 wt % of fluorine.

10. The method of claim 5, wherein R_{f} is a fluoropolyether or a perfluoropolyether.

11. The method of claim 1, wherein the graft content of pigment particles is about 3 to about 30 wt %.

12. The method of claim 2, wherein said silane material introduces isocyanante reactive groups to the surface of the pigment particles.

13. The method of claim 12, wherein the functional group is terminal hydroxyl or terminal amino group.

14. The method of claim 1, further comprising treating the pigment particles with a coupling agent to introduce a charged or chargeable group onto the surface of the pigment particles.

15. The method of claim 14, wherein said coupling agent is acrylic acid, 3-(trihydroxysilyl)propyl methylphosphonate or a molecule with a sulfonic acid or sulfonate moiety.

16. The method of claim 1, further comprising an oxidation reaction prior to step (a) to introduce acidic groups onto the surface of the pigment particles.

17. The method of claim 16, wherein said pigment particles are carbon black particles.

18. The method of claim 16, wherein the oxidation reaction is carried out with nitric acid, sulfuric acid, a chlorate, a persulfate, a perborate or a percarbonate.

19. An electrophoretic dispersion, comprising pigment particles prepared according to the method of claim 1, dispersed in a fluorinate solvent.

20. An electrophoretic dispersion, comprising two types of pigment particles dispersed in a fluorinated solvent, wherein at least one type of the pigment particles is prepared according to the method of claim 1.

21. A method for preparing pigment particles useful for an electrophoretic display, comprising reacting the pigment particles with a compound comprising a fluorinated backbone and groups attachable to the surface of the pigment particles.

22. The method of claim 21, wherein the compound is a silane compound comprising a fluorinated backbone and groups convertible to hydroxyl group.

23. The method of claim 21, wherein the fluorinated backbone is a fluoroether or a perfluoropolyether.

24. An electrophoretic dispersion, comprising pigment particles prepared according to the method of claim 21, dispersed in a fluorinate solvent.

25. An electrophoretic dispersion, comprising two types of pigment particles dispersed in a fluorinated solvent, wherein at least one type of the pigment particles is prepared according to the method of claim 21.
